(19) United States
(12) Patent Application Publication
(10) Pub. No.: US 2006/0000862 A1
(43) Pub. Date: Jan. 5, 2006

(54) Spool for fishing lines

(75) Inventor: Shigeru Kawano, Hyogo (JP)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Kawano Plastics Company, Hyogo (JP)

(21) Appl. No.: 11/101,102

(22) Filed: Apr. 7, 2005

(30) Foreign Application Priority Data
Sep. 13, 2002 (JP) 2002-268584

(51) Int. Cl. A01K 97/06

(52) U.S. Cl. 225/60

(57) ABSTRACT

A spool for fishing lines according to this invention includes: an annular cover member (2) rotatably and removably fitted on peripheral edge portions of flanges (4); a support portion (9) protuberating on an upper surface of the cover member and having front and rear portions and opposite side edge portions; a cutter portion (10) dented from one of the side edge portions of the support portion, with the front and rear portions and the other side edge portion of the support portion (9) being kept as they are; a cutter (11) embedded within the support portion (9) in such a manner that only a cutting edge (11a) thereof protrudes into the cutter portion (10); and a fishing line retaining portion (13) having a clearance defined between the support portion (9) and a surface of the cover member (2) and extending from behind the support portion (9) to the cutting edge (11a).

### BACKGROUND OF THE INVENTION

1. Field of the Invention

The present invention relates to a spool for fishing lines which facilitates use of a fishing line wound thereabout.

2. Description of the Related Art

It has been a conventional practice to sell fishing lines in a form in which a fishing line having a predetermined length is wound about a fishing line spool comprising a cylindrical core formed with flanges at opposite ends thereof.

In order to prevent a fishing line thus wound about such a spool from coming off the spool spontaneously, usually a plastic fishing line fastener in the form of a thin sheet band is attached to the wound fishing line to abut on a fishing line surface resiliently.

There has been proposed a fishing line fastener provided with a cutter for cutting a fishing line paid out of the spool to a predetermined length and a fishing line retaining means for retaining a cut end portion of the fishing line (see Japanese Patent Laid-Open Publication No. 2000-157134 (claim 1 and FIG. 6) for example).

The fishing line fastener described in this patent document comprises a fishing line introducing portion for introducing the fishing line from one side edge of the fishing line fastener, a fishing line pay-out hole continuous with the fishing line introducing portion, and a cutter portion provided on the outer periphery of the fishing line fastener for cutting off a portion of the fishing line paid out from the fishing line pay-out hole and retaining the cut end of the remaining fishing line.

Specifically, the cutter portion has such a structure that a base plate having a cutter blade is laterally fitted into a cutter rest formed integrally with the fishing line fastener, wherein the base plate is formed by bending a single sheet of metal material and the tongue-shaped cutter blade formed by obliquely raising a substantially U-shaped notched portion formed on top of the base plate.

In using the fishing line wound about the spool, the fishing line paid out to a required length from the fishing line pay-out hole is put between the cutter blade and the base plate and then pulled back toward the fishing line pay-out hole strongly. By so doing, the fishing line is cut at the root of the cutter blade while at the same time the cut end of the remaining fishing line is retained at the root of the cutter blade because the cutter blade is formed to protrude toward the upper cutter rest obliquely relative to the length of the fishing line fastener.

With the aforementioned conventional fishing line fastener, however, the fishing line is drawn to the root of the tongue-shaped cutter blade formed by raising the substantially U-shaped notch portion from the top of the base plate and the cut end of the fishing line is retained as caught at the root of the cutter blade. For this reason, the fishing line wound about the spool cannot be drawn out next time by picking up the end portion thereof until the end portion retained at the root of the cutter blade has been detached therefrom.

Further, with a common commercially-available spool, a fishing line having a predetermined length is wound thereabout to form a fishing line layer having a top surface which does not reach the peripheral edges of the flanges but lies at about a midpoint on the inner surface of each flange to leave the upper half of the flange free. For this reason, the fishing line fastener attached to the wound fishing line sinks in the gap between the opposite flanges to contact the top surface of the fishing line layer.

To draw out the fishing line from the spool by only fingertips without using any tool, it is required that the fingertips be inserted into the gap between the opposite flanges to detach and pick up the fishing line end portion retained at the root of the cutter blade of the fishing line fastener attached to the wound fishing line. Because the fingertips cannot be inserted deeply into the gap between the opposite flange of the common spool, only a large-sized spool defining a large gap between its opposite flanges allows the fishing line end portion to be detached from the root of the cutter blade, picked up and drawn out by the fingertips only.

Even with such a large-sized spool, when the amount of fishing line remaining in the spool decreases to make the fishing line fastener sink deeply into the gap between the opposite flanges, it becomes difficult to insert fingertips into the gap to handle the fishing line.

Further, as the tongue-shaped cutter blade is formed by raising the substantially U-shaped notch portion from the top surface of the base plate, it is highly possible that the fingertips are injured by the cutter blade in such an operation as to detach the fishing line end portion retained as caught by the root of the cutter blade.

Accordingly, it is an object of the present invention to provide a spool for fishing lines which is capable of allowing a fishing line to be drawn out therefrom, cutting the fishing line and retaining the cut end of the fishing line easily under a constant condition irrespective of the size of the spool and the amount of fishing line wound about the spool and which is safe and easy to handle with no possibility of allowing a fingertip to touch the cutting edge of a cutter.

### SUMMARY OF THE INVENTION

According to the present invention, there is provided a spool for fishing lines comprising: a core having a pair of opposite flanges at opposite ends thereof; a belt-shaped annular cover member of plastic rotatably and removably fitted on peripheral edge portions of respective of the flanges; a support portion protuberating on an upper surface of the cover member and having front and rear portions and opposite side edge portions; a notched cutter portion dented from one of the side edge portions of the support portion, with the front and rear portions and the other side edge of the support portion being kept as they are; a cutter embedded within the support portion in such a manner that a cutting edge thereof protrudes sidewise; and a fishing line retaining portion having a clearance defined between the support portion and the cover member and extending along a peripheral portion of the support member to reach the cutting edge.

In this construction, the peripheral edge portions of the opposite flanges forming the spool define opposite cutout steps each L-shaped in section; and the cover member has opposite side edges snap-fitted on the opposite cutout steps. A fishing line can be drawn out of the cover member from the spool through either a fishing line pick-up cutout formed at one side edge of the cover member or a clearance formed between the peripheral edge portions of the flanges and the cover member by utilizing looseness therebetween.

According to the spool for fishing lines of the present invention thus constructed, since the cover member is fitted on the peripheral edge portions of the opposite flanges to cover a fishing line accommodating space defined between the opposite flanges, the user has to perform such a simple operation as to draw the fishing line out of the spool to a required length by fingertips holding a fishing line end exposed from the cover member, draw a cutting portion of the fishing line into the fishing line retaining portion formed between the support portion and the cover member, and put the cutting portion on the cutting edge of the cutter to cut the fishing line. Thus, the spool is capable of allowing the fishing line to be drawn out therefrom and cutting the fishing line under a constant condition irrespective of the size of the spool and the amount of fishing line wound about the spool.

After cutting, the cut end portion of the fishing line is stretched by its resilience to separate from the cutting edge but is retained as it is by the fishing line retaining portion. For this reason, the cut end portion of the fishing line can be easily picked up when the fishing line is used next time. Thus, the spool facilitates the handling of the fishing line. What is more, since a portion of the fishing line which lies apart from the cutting edge is held in cutting the fishing line, the spool offers high safety because there is no possibility that a fingertip touches the cutting edge.

If the cutter portion has a feature such that: the cutter portion exposes a surface of the cover member substantially triangularly; the cutter edge extends in parallel with the surface of the cover member while protruding obliquely relative to a length of the cover member and reawardly in the cutter portion, the fishing line can be drawn out of the fishing line retaining portion into the cutter portion and then put on the cutting edge by being bent to form an acute angle. Thus, the fishing line can be cut with a force causing the fishing line to slide on the cutting edge in addition to the pulling force. For this reason, cutting of the fishing line can be achieved reliably without undue force.

There is no particular limitation on the form of the fishing line retaining portion having a clearance defined between the support portion and the cover member to extend along a peripheral portion of the support member to reach the cutting edge as long as the fishing line retaining portion allows the fishing line to be drawn into the cutter portion and then cut properly. However, in the case where the position at which the fishing line is drawn out of the cover member from the spool is established reawardly of the support portion, it is preferable that the fishing line retaining portion extends from behind the cutter portion to the cutting edge via a front portion of the support portion and has a retaining piece projecting from the front portion of the support portion toward a surface of the cover member within the fishing line retaining portion. In cutting the fishing line drawn out of the spool, this arrangement allows an operation including entraining the cutting portion of the fishing line around the front portion of the support portion from behind the cutter portion, drawing the cutting portion into the fishing line retaining portion while sliding it on a surface of the cover member and then putting it on the cutting edge to be achieved easily.

After cutting, the cut end portion of the fishing line is stretched by its resilience to separate from the cutting edge but is reliably retained within the fishing line retaining portion by the retaining piece projecting from the front portion of the support portion toward the surface of the cover member. Thus, the fishing line can be handled easily.

Alternatively, in the case where the position at which the fishing line is drawn out of the cover member from the spool is established forwardly of the support portion, it is preferable that the fishing line retaining portion extends in a front portion of the support portion situated on the side where the cutter portion is dented to the cutting edge and has a retaining piece projecting from the support portion toward a surface of the cover member within the fishing line retaining portion. In cutting the fishing line drawn out of the spool, this arrangement allows an operation including drawing the cutting portion of the fishing line into the fishing line retaining portion while keeping it substantially linearly and putting the cutting portion on the cutting edge to be achieved easily in an almost one-touch fashion.

In this case also, the cut end portion of the fishing line is stretched by its resilience to separate from the cutting edge but is reliably retained within the fishing line retaining portion by the retaining piece projecting from a side edge portion toward the surface of the cover member. Thus, the fishing line can be handled easily.

Preferably, the support portion protuberating on the upper surface of the cover member includes a seat integral with the cover member, and an outer cover coupled to the seat, wherein: the cutter is placed on the seat at a fixed position; and an engagement projection projecting from a lower surface of the outer cover is inserted through and engaged with engagement holes each formed through respective of the cutter and the seat to fix the cutter to the seat. This feature enables the cutter mounting operation to be achieved easily and reliably and hence makes volume production of the spool possible. Thus, the spool can be provided at a lower price.

If the cover member has a fitting hole at a suitable position and a hanger is attached to the fitting hole, the spool can be conveniently displayed in a hanging state for sale at a shop. Because the hanger is easily removable, the hanger does not become a nuisance after the spool has been sold to the user.

The foregoing and other objects, features and attendant advantages of the present invention will become more apparent from the reading of the following detailed description of the invention in conjunction with the accompanying drawings.

### BRIEF DESCRIPTION OF THE DRAWINGS

FIG. 1 is a perspective view showing a portion of a spool for fishing lines according to an embodiment of the present invention;

FIG. 2 is a fragmentary sectional view illustrating how a cover member is fitted on peripheral edge portions of flanges;

FIG. 3 is an enlarged plan view of a support portion protuberating on the cover member;

FIG. 4 is a side view of the support portion shown in FIG. 3;

FIG. 5 is a perspective view of the support portion shown in FIG. 3;

FIG. 6 is an enlarged plan view of a support portion protuberating on a cover member according to another embodiment of the present invention;

FIG. 7 is a sectional view taken centrally of the support portion shown in FIG. 6;

FIG. 8 is a perspective view of the support portion shown in FIG. 6;

FIG. 9 is a perspective view showing spools for fishing lines coupled to each other for use according to the present invention;

FIG. 10 is an enlarged plan view of a support portion protuberating on a cover member according to an embodiment of the present invention where the position at which the fishing line is drawn out of the spool is different from other embodiments;

FIG. 11 is a perspective view of the support portion shown in FIG. 10;

FIG. 12(A) is a perspective view showing a portion of concern in a state where a cover member and a hanger is separated from each other; and

FIG. 12(B) is a front elevational view showing the portion of concern in a state where the hanger is fitted on the cover member.

### DETAILED DESCRIPTION OF THE PREFERRED EMBODIMENTS

Hereinafter, embodiments of the present invention will be described in detail with reference to the drawings.

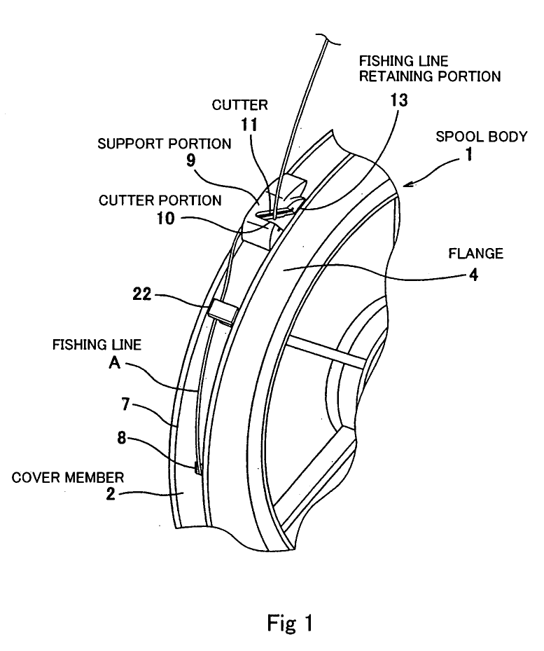

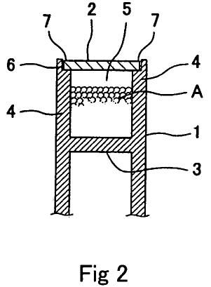

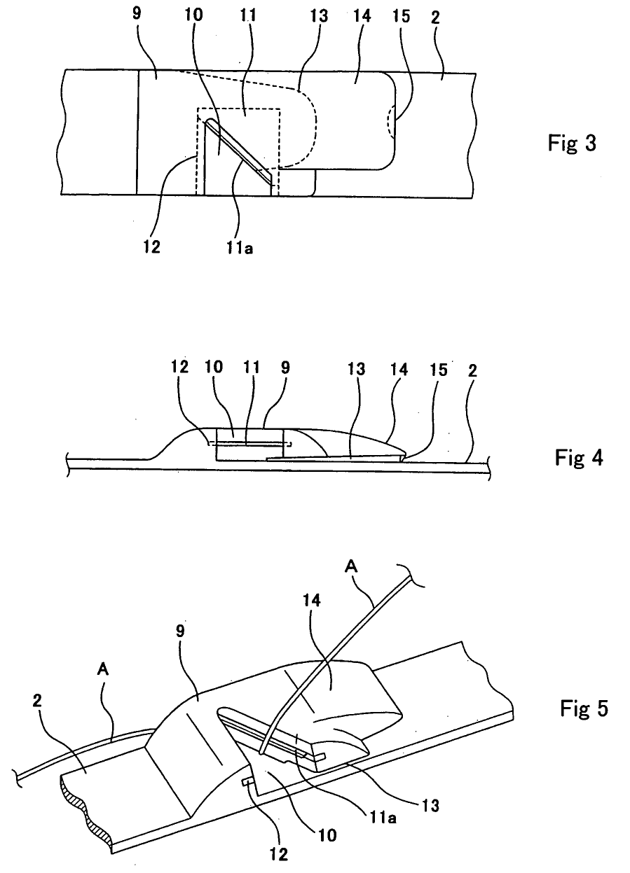

FIG. 1 is a perspective view showing a portion of a spool for fishing lines according to an embodiment of the present invention; FIG. 2 is a fragmentary sectional view illustrating how a cover member is fitted on peripheral edge portions of flanges; FIG. 3 is an enlarged plan view of a support portion protuberating on the cover member; FIG. 4 is a side view of the support portion shown in FIG. 3; and FIG. 5 is a perspective view of the support portion shown in FIG. 3.

In the drawings, reference numeral 1 designates a spool body and reference numeral 2 designates an annular cover member fitted on the spool body 1.

The spool body 1 is molded of a plastic material such as PS resin or the like and comprises a core 3 and flanges 4 at opposite ends of the core 3. The spool body 1 is sized appropriately for convenience in use. The spool body 1 has basically the same form as a common spool.

As shown in FIG. 2, the cover member 2 is an annular cover shaped like an endless belt and configured to cover the whole of a fishing line accommodating space 5 defined between the opposite flanges 4 of the spool body 1. The cover member 2 is molded of a plastic material such as polyethylene or the like. The opposite flanges 4 of the spool body 1 have their respective peripheral edge portions having opposite cutout step portions 6 each L-shaped in section for receiving the cover member 2. The cover member 2 is rotatably and removably fitted on the spool body 1 by engaging opposite side edges 7 of the cover member 2 with the cutout step portions 6 in a snap-fit fashion.

Here, the opposite side edges 7 of the cover member 2 and the step portions 6 of the flange peripheral edge portions have looseness therebetween to a certain extent. For this reason, the cover member 2 can revolve with little resistance and can be fitted on and removed from the flange peripheral edge portions easily by utilizing artificial deformation of the cover member 2.

A fishing line A within the spool, more specifically, within the fishing line accommodating space 5 covered with the cover member 2 can be drawn out of the cover member 2 through either a clearance defined between the flange peripheral portions and the side edges 7 of the cover member 2 or a fishing line pick-up cutout 8 formed at one side edge 7 of the cover member 2.

A support portion 9 protuberates on an upper surface of the cover member 2. The support portion 9 has front and rear portions and opposite side edge portions. Note that in this embodiment the direction in which the fishing line A drawn out of the spool is drawn into the support portion 9 is the forward direction. The support portion 9 has a notched cutter portion 10 dented from one of the side edge portions of the support portion 9, with the front and rear portions and the other side edge portion of the support portion being kept as they are. A surface of the cover member 2 is exposed within the cutter portion 10.

A cutter 11 is fitted in the support portion 9 in a partially embedded fashion. Only a cutting edge 11a of the cutter 11 protrudes into the cutter portion 10 in such a manner as to be positioned slightly above the cover member surface. In this embodiment, the cutter portion 10 is shaped substantially triangular in plan, while the cutting edge 11a protrudes from a reawardly oriented front wall of the cutter portion 10 which crosses the cover member surface obliquely.

Also in this embodiment, the cutter 11 is mounted on the support portion 9 by forming a cutter receiving recess 12 in the support portion 9 from the open side of the cutter portion 10, fitting the cutter 11 into the cutter receiving recess 12, and then filling the recess 12 with a space filler to fix the cutter 11.

The cutting edge 11a of the cutter 11 protruding into the cutter portion 10 is positioned deep in the cutter portion 10. The size, form and the like of each of portions associated with the cutter 11 are established appropriately so as to cut the fishing line A but prevent a fingertip from penetrating into the cutter portion 10 from either of the upper side and the lateral side of the support portion 9 on which the cutter portion 10 is open.

The support portion 9 has a fishing line retaining portion 13 having a clearance extending from behind the cutter 11 up to the cutting edge 11a, the clearance being formed by separating the front portion of the support portion 9 from the cover member surface.

In this embodiment an upper surface of the front portion of the support portion 9 is inclined toward the cover member surface to form a tongue-like extension 14. The amount of spacing between the extension 14 and the cover member surface increases gradually as the extension 14 extends toward its tip, to allow the fishing line A to be easily introduced into the retaining portion 13. The tip of the extension 14 is formed with a retaining piece 15 projecting toward the cover member surface for retaining the fishing line A within the retaining portion 13.

Thus, the fishing line A is drawn into the fishing line retaining portion 13 by being forcibly passed between the retaining piece 15 and the cover member surface in such a way that the fishing line A is slid on the cover member surface by the user holding fishing line end by hand.

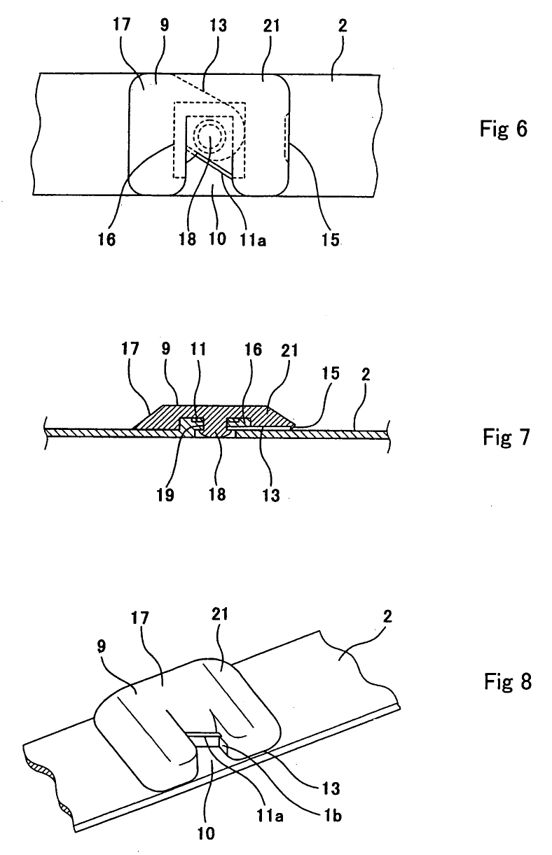

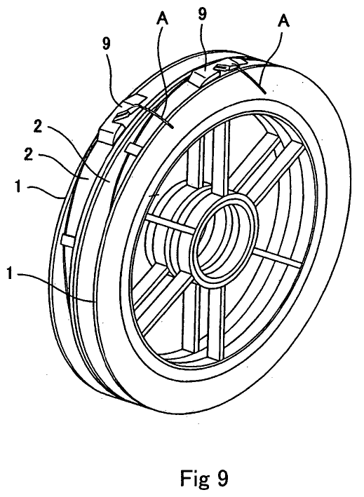

FIG. 6 is an enlarged plan view of a support portion protuberating on a cover member according to another embodiment of the present invention; FIG. 7 is a sectional view taken centrally of the support portion shown in FIG. 6; and FIG. 8 is a perspective view of the support portion shown in FIG. 6.

In this embodiment, the support portion 9 comprises a seat 16 integral with a cover member surface, and an outer cover 17 coupled to the seat 16. The cutter 11 is placed on the seat 16 at a fixed position and the outer cover 17 placed to cover the seat 16. An engagement projection 18 projecting from a lower surface of the outer cover 17 is inserted through fitting holes 19 each formed through a respective one of the cutter 11 and the seat 16 to engage the underside of the seat 16.

In this case, the lower surface of the outer cover 17 is pressed against the cover member surface around the seat 16. For this reason, the lower surface of the outer cover 17 in an extent from behind the cutter 11 to the cutting edge 11a is raised from the cover member surface to form fishing line retaining portion 13 having a clearance.

In this embodiment also, the amount of spacing between a front portion 21 of the outer cover 17 and the cover member surface increases gradually as the front portion extends toward its tip, to allow the fishing line A to be easily introduced into the retaining portion 13. The tip of the front portion 21 is formed with retaining piece 15 projecting toward the cover member surface.

In using the spool for fishing lines thus constructed according to the present invention, the end portion of the fishing line A is previously retained at the fishing line retaining portion 13 by being drawn out of the cover member 2 and then into the fishing line retaining portion 13. When using the fishing line A, the fishing line A is drawn out of the spool to a required length with the fishing line end portion held by fingertips. A cutting portion of the fishing line A is entrained around the front side of the support portion 9 from behind the cutter 11, then passed between the retaining piece 15 and the cover member surface into the fishing line retaining portion 13 by being slid on the cover member surface, and then entrained to the cutter portion 10. Then, the fishing line A is cut either by upwardly pulling the fishing line A to press it against the cutting edge 11a of the cutter 11 relatively strongly or by moving the fishing line A on the cutting edge 11a. At that time, the fishing line A is pressed against the cover member surface by the other hand at a location in the rear of the support portion 9 in order to prevent the cutting position of the fishing line A from being displaced. In this embodiment a fishing line presser piece 22 (see FIG. 1) is provided on the cover member surface at a location in the rear of the support portion 9.

In this way the fishing line A is entrained to the cutter portion 10 through the fishing line retaining portion 13 and then cut. The cut end portion of the fishing line A is retained by the fishing line retaining portion 13 while being inhibited to come out of the retaining portion 13 by the retaining piece 15. Thus, the cut end portion of the fishing line A can be easily picked up when using the fishing line A next time.

Since the basic form of the spool body 1 of the spool for fishing lines according to the present invention is completely the same as that of a common spool, plural spools of the same size can be coupled to each other side by side, as shown in FIG. 9. This arrangement is convenient in such a use that fishing lines of different types each wound about a respective one of the spools are used for different purposes.

While any one of the foregoing embodiments is directed to the case where the position at which the fishing line A is drawn out of the spool is established rearwardly of the support portion 9, the position at which the fishing line A is drawn out of the spool may be established forwardly of the support portion 9.

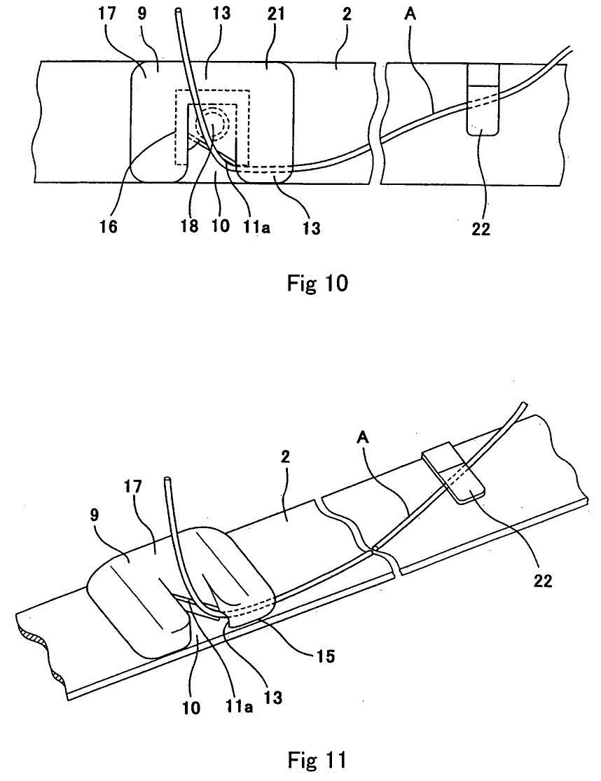

FIG. 10 is an enlarged plan view, corresponding to FIG. 6, of a support portion protuberating on a cover member according to an embodiment of the present invention where the position at which the fishing line is drawn out of the spool is established forwardly of the support portion; and FIG. 11 is a perspective view of the support portion shown in FIG. 10.

In the case where the position at which the fishing line A is drawn out of the spool is established forwardly of the support portion 9, the fishing line retaining portion 13 formed between the support portion 9 and the cover member surface extends in a front portion of the support portion 9 situated on the side where the cutter portion 10 is dented to reach the cutter edge 11a of the cutter 11 and has a retaining piece 15 projecting from the support portion 9 toward the cover member surface within the fishing line retaining portion 9, as shown in FIGS. 10 and 11. In this arrangement, the fishing line retaining portion 13 has a simplified configuration. In cutting the fishing line A drawn out of the spool, this arrangement allows an operation including drawing the cutting portion of the fishing line A into the fishing line retaining portion 13 while keeping it substantially linearly and putting it on the cutting edge 11a of the cutter 11 to be achieved easily in an almost one-touch fashion.

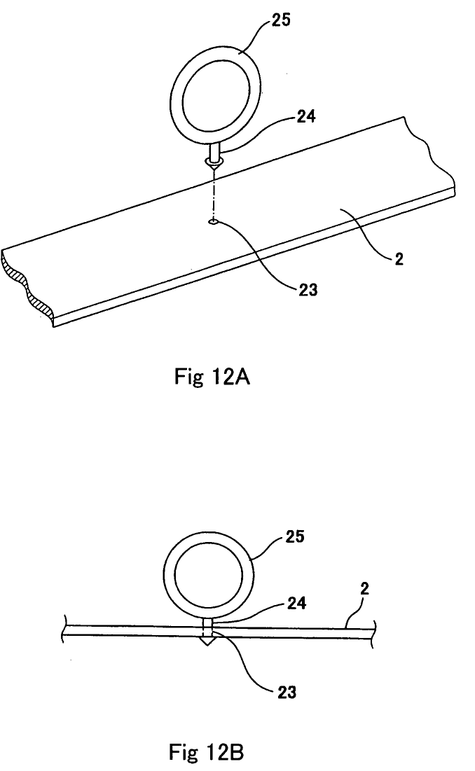

If the cover member 2 has a fitting hole 23 at a suitable position and is fitted with a hanger 25 having an engagement portion 24 inserted into and engaged by the fitting hole 23 as shown in FIGS. 12(A) and 12(B), the spool can be conveniently displayed in a hanging state for sale at a shop by means of the hanger 25. Because the hanger 25 can be easily removed if the user does not need the hanger 25, the hanger 25 does not become a nuisance after the spool has been sold to the user.

The present invention can be practiced in the foregoing embodiments. In the spool for fishing lines according to the present invention, the cutter and the support portion configured to retain the cut end portion of the fishing line are provided on the cover member rotatably fitted on the flange peripheral edge portions of the spool. The spool thus constructed allows a fishing line to be drawn out therefrom and cut easily under a constant condition irrespective of the size of the spool and the amount of fishing line wound about the spool. Moreover, since the cut end portion of the fishing line can be retained on the cover member surface, the fishing line can be drawn out easily for next-time use. Further, since the cutting edge of the cutter is positioned deep in the cutter portion dented into the support portion to prevent a fingertip from touching the cutting edge, the spool has high safety and easy-to-handle characteristics.

It will be apparent from the foregoing description that many improvements and other embodiments of the present invention may occur to those skilled in the art. Therefore, the foregoing description should be construed as an illustration only and is provided for the purpose of teaching the best mode for carrying out the present invention to those skilled in the art. The details of the structure and/or the function of the present invention can be modified substantially without departing from the spirit of the present invention.

What is claimed is:

1. A spool for fishing lines comprising: a core having a pair of opposite flanges at opposite ends thereof; a belt-shaped annular cover member of plastic rotatably and removably fitted on peripheral edge portions of respective of the flanges; a support portion protuberating on an upper surface of the cover member and having front and rear portions and opposite side edge portions; a notched cutter portion dented from one of the side edge portions of the support portion, with the front and rear portions and the other side edge portion of the support portion being kept as they are; a cutter embedded within the support portion in such a manner that a cutting edge thereof protrudes sidewise; and a fishing line retaining portion having a clearance defined between the support portion and the cover member and extending along a peripheral portion of the support portion to reach the cutting edge.

2. The spool according to claim 1, wherein: the peripheral edge portions of the opposite flanges forming the spool define opposite cutout steps each L-shaped in section; and the cover member has opposite side edges snap-fitted on the opposite cutout steps.

3. The spool according to claim 1 or 2, wherein: the cutter portion exposes a surface of the cover member substantially triangularly; and the cutting edge extends in parallel with the surface of the cover member while protruding obliquely relative to a length of the cover member and reawardly in the cutter portion.

4. The spool according to any one of claims 1 to 3, wherein the peripheral edge portions of the flanges and the cover member are loosely engaged with each other to define a clearance therebetween for allowing a fishing line to be drawn out of the spool therethrough.

5. The spool according to any one of claims 1 to 4, wherein the fishing line retaining portion extends from behind the cutter portion to the cutting edge via a front portion of the support portion and has a retaining piece projecting from the front portion of the support portion toward a surface of the cover member within the fishing line retaining portion.

6. The spool according to any one of claims 1 to 4, wherein: the fishing line retaining portion extends in a front portion of the support portion situated on the side where the cutter portion is dented to reach the cutting edge and has a retaining piece projecting from the support portion toward a surface of the cover member within the fishing line retaining portion.

7. The spool according to any one of claims 1 to 6, wherein: the support portion includes a seat integral with the cover member, and an outer cover coupled to the seat, wherein: the cutter is placed on the seat at a fixed position; and an engagement projection projecting from a lower surface of the outer cover is inserted through and engaged with engagement holes each formed through respective of the cutter and the seat to fix the cutter to the seat.

8. The spool according to any one of claims 1 to 3, wherein: the cover member has a fitting hole at a suitable position and a hanger is attached to the fitting hole.
